(19) United States
(12) Patent Application Publication
(10) Pub. No.: US 2024/0339599 A1
(43) Pub. Date: Oct. 10, 2024

(54) ELECTROCHEMICAL DEVICE AND ELECTRONIC DEVICE

(71) Applicant: Ningde Amperex Technology Limited, Ningde (CN)

(72) Inventor: Xiaohu CAI, Ningde (CN)

(73) Assignee: Ningde Amperex Technology Limited, Ningde (CN)

(21) Appl. No.: 18/621,871

(22) Filed: Mar. 29, 2024

(30) Foreign Application Priority Data
Apr. 7, 2023 (CN) 202310368414.9

(51) Int. Cl. H01M 4/36; H01M 4/02; H01M 4/62; H01M 4/66; H01M 10/0587

(52) U.S. Cl. CPC H01M 4/366; H01M 4/622; H01M 4/625; H01M 10/0587; H01M 2004/021; H01M 2004/028; H01M 4/661

(57) ABSTRACT

An electrochemical device includes a jelly-roll electrode assembly and a packaging shell. The jelly-roll electrode assembly includes a positive electrode plate, a negative electrode plate, and a separator. The positive electrode plate includes a positive current collector, a first layer, and a second layer. The first layer includes inorganic particles. Based on a mass of the first layer, a mass percent of the inorganic particles is greater than or equal to 50%. The second layer includes a positive active material. A thickness of the first layer is d₁ μm. An area of orthographic projection of the first layer is S₁ mm², an area of orthographic projection of the second layer is S₂ mm², satisfying: d₁/S₁≥2×10⁻⁶, and d₁/S₂≥2.5×10⁻⁶. The first layer is in contact with the packaging shell.

### CROSS-REFERENCE TO RELATED APPLICATIONS

This application claims priority to Chinese Patent Application No. 202310368414.9, filed on Apr. 7, 2023, the whole disclosure of which is incorporated herein by reference.

### TECHNICAL FIELD

This application relates to the field of electrochemical energy storage, and in particular, to an electrochemical device and an electronic device.

### BACKGROUND

With the development of electrochemical energy storage technology, higher requirements have been imposed on the safety performance and cycle performance of electrochemical devices (such as a lithium-ion battery). For example, the requirement on the cycle performance of the electrochemical devices is increasingly higher, and the requirements on the safety performance of the electrochemical devices in a case of dropping and/or nail penetration are increasingly higher. Therefore, further improvements on such performance metrics are expected.

### SUMMARY

This application provides an electrochemical device. The electrochemical device includes a jelly-roll electrode assembly and a packaging shell. The jelly-roll electrode assembly includes a positive electrode plate, a negative electrode plate, and a separator. The separator is disposed between the positive electrode plate and the negative electrode plate. The positive electrode plate includes a positive current collector, a first layer, and a second layer. The first layer is disposed on a surface of the positive current collector. The second layer is disposed on a surface of the first layer. The first layer includes inorganic particles. Based on a mass of the first layer, a mass percent of the inorganic particles is greater than or equal to 50%. The second layer includes a positive active material. Based on a mass of the second layer, a mass percent of the positive active material is greater than 90%. A thickness of the first layer is d₁ μm. An area of orthographic projection of the first layer on the positive current collector is S₁ mm², an area of orthographic projection of the second layer on the positive current collector is S₂ mm², d₁/S₁≥2×10⁻⁶, and d₁/S₂≥2.5×10⁻⁶. The first layer is in contact with the packaging shell.

In some embodiments, 8×10⁴≤S₁≤6×10⁵, and 7×10⁴≤S₂≤5.5×10⁵. In some embodiments, along a thickness direction of the jelly-roll electrode assembly, an area of orthographic projection of the jelly-roll electrode assembly is S₃ mm², 1≤(S₁−S₂)/S₃≤2. In some embodiments, along a thickness direction of the jelly-roll electrode assembly, an area of orthographic projection of the jelly-roll electrode assembly is S₃ mm², 1.2≤(S₁−S₂)/S₃≤2.

In some embodiments, the thickness of the first layer is 0.5 μm to 10 μm. In some embodiments, the thickness of the first layer is 3 μm to 7 μm. In some embodiments, the positive current collector includes an aluminum foil. A thickness of the aluminum foil is 7 μm to 20 μm.

In some embodiments, the first layer further includes a first conductive agent and a first binder. A mass ratio between the inorganic particles, the first conductive agent, and the first binder is (50 to 95): (0.5 to 10): (2 to 49.5). In some embodiments, the inorganic particles include at least one selected from the group consisting of boehmite, diaspore, aluminum oxide, barium sulfate, calcium sulfate, and calcium silicate. In some embodiments, Dᵥ₅₀ of the inorganic particles is D₀ μm, 0.3≤D₀≤5, and preferably 0.6≤D₀≤3. In some embodiments, D₀ and the area of orthographic projection S₂ of the second layer on the positive current collector satisfy: 2.1×10^{'6}≤D₀/S₂≤8.6×10⁻⁴.

In some embodiments, the first conductive agent includes at least one selected from the group consisting of conductive carbon black, carbon fibers, graphene, and carbon nanotubes. In some embodiments, the first binder includes at least one selected from the group consisting of polypropylene, a polyacrylate ester, an acrylonitrile multi-copolymer, and a carboxymethyl cellulose salt. In some embodiments, a bonding force between the first layer and the positive current collector is greater than or equal to 150 N/m.

An embodiment of this application further provides an electronic device, including the electrochemical device.

In this application, the thickness di of the first layer and the area of orthographic projection S₁ of the first layer on the positive current collector are set to satisfy: d₁/S₁≥2×10⁻⁶, the thickness d₁ of the first layer and the area of orthographic projection S₂ of the second layer on the positive current collector are set to satisfy: d₁/S₂≥2.5×10⁻⁶, and the first layer is in contact with the packaging shell. In this way, it is ensured that a first layer that is in contact with the packaging shell and not covered by the second layer exists in the positive electrode plate. Further, the thickness of the first layer and the areas of orthographic projection of the first layer and the second layer of the jelly-roll electrode assembly are set to satisfy the above ranges, thereby reducing the wobbling between the bare cell and the packaging shell, and enhancing the safety performance of the electrochemical device.

### BRIEF DESCRIPTION OF DRAWINGS

FIG. 1 is a cross-sectional view of a positive electrode plate sectioned along a length direction according to some embodiments;

FIG. 2 is a cross-sectional view of a positive electrode plate sectioned along a length direction according to some other embodiments; and

FIG. 3 is a cross-sectional view of a positive electrode plate sectioned along a length direction according to still some other embodiments.

### DETAILED DESCRIPTION

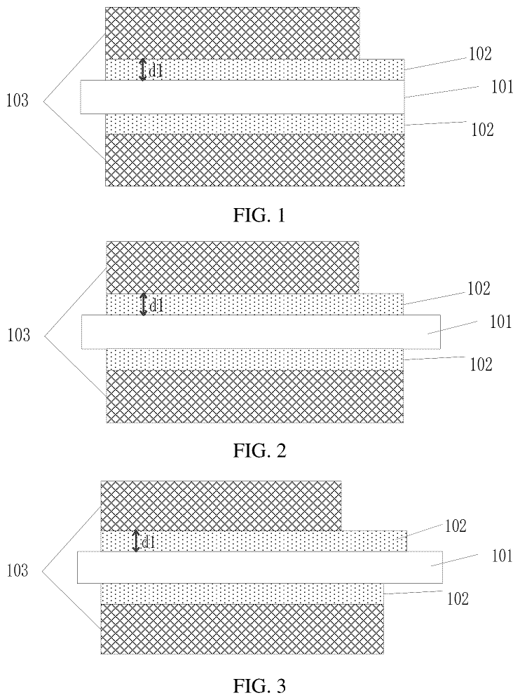

The following embodiments enable a person skilled in the art to understand this application more comprehensively, but without limiting this application in any way. This application provides an electrochemical device. The electrochemical device includes a jelly-roll electrode assembly and a packaging shell. In some embodiments, the jelly-roll electrode assembly includes a positive electrode plate, a negative electrode plate, and a separator. The separator is disposed between the positive electrode plate and the negative electrode plate to isolate the positive electrode plate from the negative electrode plate. As shown in FIG. 1 and FIG. 2, in some embodiments, the positive electrode plate includes a positive current collector 101, a first layer 102, and a second layer 103. In some embodiments, the first layer 102 is located between the positive current collector 101 and the second layer 103. In some embodiments, the first layer 102 is disposed on a surface of the positive current collector 101. The second layer 103 is disposed on a surface of the first layer 102. Understandably, although the first layer 102 and the second layer 103 in FIG. 1 are illustrated to be located on two sides of the positive current collector 101 respectively, the positioning is just exemplary. The first layer 102 and the second layer 103 may be located on just one side of the positive current collector 101. For example, in FIG. 1 and FIG. 2, the first layer 102 and the second layer 103 exist on just the upper side of the positive current collector 101.

In some embodiments, the second layer 103 includes a positive active material. Based on a mass of the second layer 103, a mass percent of the positive active material is greater than 90%. In some embodiments, a thickness of the first layer 102 is d₁ μm. An area of orthographic projection of the first layer 102 on the positive current collector 101 is S₁ mm², an area of orthographic projection of the second layer 103 on the positive current collector 101 is S₂ mm², d₁/S₁≥2×10⁻⁶, and d₁/S₂≥2.5×10⁻⁶. Orthographic projection means a projection of an object in which a centerline of a projected ray is perpendicular to the projection plane. In this application, if the first layer 102 and the second layer 103 exist on both sides of the positive current collector 101, then the area of orthographic projection of the first layer 102 and the second layer 103 is the area of orthographic projection of the corresponding layer on any one of the two sides, whichever is larger in area. For example, in FIG. 1, the area of the second layer 103 at the lower side of the positive current collector 101 is larger than the area of the second layer 103 at the upper side of the positive current collector 101, and therefore, the area of orthographic projection of the second layer 103 in FIG. 1 is the area of orthographic projection of the second layer 103 at the lower side of the positive current collector 101. When the first layer 102 and the second layer 103 are located on both sides of the positive current collector 101, the projected area referred to herein is a sum of the projected areas of the first layer 102 or the second layer 103 on the two sides of the positive electrode.

In some embodiments, the first layer 102 includes inorganic particles. Based on a mass of the first layer 102, a mass percent of the inorganic particles is greater than or equal to 50%. In some embodiments, the existence of the inorganic particles can, on the one hand, alleviate the adverse effects of the burrs caused by the positive current collector 101 after cutting. On the other hand, the inorganic particles can increase the overall resistance of the first layer 102, and enhance the safety performance of the electrochemical device, for example, reduce a short-circuit current, reduce the rate of heat generation of the electrochemical device, thereby avoiding the emergence of high-risk problems such as thermal runaway and fire caused by accumulation of heat.

In some embodiments, the first layer (102) is in contact with the packaging shell (not shown). In some embodiments, the packaging shell includes an aluminum laminated film. Typically, the bare cell is packaged in the packaging shell. As shown in FIG. 1 to FIG. 3, the first layer 102 on one side of the positive current collector 101 includes a part that is not covered by the second layer 103. In this case, the positive electrode plate on the left side of FIG. 1, FIG. 2, and FIG. 3 is located on the inner side of the jelly-roll structure. The positive electrode plate on the right side of FIG. 1 to FIG. 3 is located on the outer side of the jelly-roll structure. In this way, the first layer 102, which is located on the outer side of the jelly-roll structure and is not covered by the second layer 103, can be brought into contact with the packaging shell. In other words, the first layer 102 not covered by the second layer 103 is located at least at the outermost coil of the jelly-roll electrode assembly. As shown in FIG. 2, on the first layer 102, in some embodiments, a piece of insulating tape (not shown) is affixed to a region of the positive current collector 101, where the region is located on the outer side of the jelly-roll structure and is not covered by the first layer 102 or the second layer 103. Typically, a friction coefficient between the first layer 102 and the packaging shell is greater than the friction coefficient between the positive current collector 101 and the packaging shell, thereby effectively reducing the wobbling between the bare cell and the packaging shell, and reducing the failure of the electrochemical device during a drop. The thickness di of the first layer 102 and the area of orthographic projection Si of the first layer 102 are set to satisfy: d₁/S₁≥2×10⁻⁶, the thickness di of the first layer 102 and the area of orthographic projection S₂ of the second layer 103 are set to satisfy: d₁/S₂≥2.5×10⁻⁶, and the first layer 102 is in contact with the packaging shell. In this way, it is ensured that a part of the first layer 102 exists in the positive electrode plate, where the part is in contact with the packaging shell and is not covered by the second layer 103, thereby reducing the wobbling between the bare cell and the packaging shell, and enhancing the safety performance of the electrochemical device. In some embodiments, 8×10⁴≤S₁≤6×10⁵, and 7×10⁴≤S₂≤5.5×10⁵. The area of orthographic projection S₁ of the first layer 102 and the area of orthographic projection S₂ of the second layer 103 determine the number of wound layers of the battery or the dimensions of the battery. In a safety test such as a nail penetration test or drop test, the amount of heat produced by the battery, the weight of the battery, the dimensions of the battery, and the like directly affect the pass rate of the safety test (in a case that the thickness di of the first layer 102 is constant). An appropriate matching thickness d₁ of the first layer 102 is determined based on the area of orthographic projection S₁ and the area of orthographic projection S₂, thereby achieving higher safety performance.

In some embodiments, along a thickness direction of the jelly-roll electrode assembly, an area of orthographic projection of the jelly-roll electrode assembly is S₃ mm², 1≤(S₁−S₂)/S₃≤2. In this case, the positive current collector 101 on the outer coil of the jelly-roll electrode assembly can be fully covered by the first layer 102. In some embodiments, along a thickness direction of the jelly-roll electrode assembly, an area of orthographic projection of the jelly-roll electrode assembly is S₃ mm², 1.2 ≤(S₁−S₂)/S₃≤2. In this case, the positive current collector 101 on the outer coil of the jelly-roll electrode assembly is at least partially not covered by the first layer 102. In some embodiments, the thickness d₁ of the first layer 102 is 0.5 μm to 10 μm. If the thickness di of the first layer 102 is excessive, then the loss in the energy density of the electrochemical device is relatively large. If the thickness di of the first layer 102 is deficient, then the effect of the first layer 102 in enhancing the safety performance of the electrochemical device is relatively limited. In some embodiments, the thickness d₁ of the first layer 102 is 3 μm to 7 μm. This setting is conducive to enhancing the safety performance of the electrochemical device, such as the safety performance in a case of dropping the electrochemical device, without significantly impairing the energy density of the electrochemical device.

In some embodiments, the positive current collector 101 may be an aluminum foil, or may be another positive current collector commonly used in this field. In some embodiments, a thickness of the aluminum foil is 7 μm to 20 μm. In this case, the electrochemical device can maintain good cycle performance and safety performance. In some embodiments, the thickness of the aluminum foil is 9 μm to 13 μm.

In some embodiments, the first layer 102 further includes a first conductive agent and a first binder. A mass ratio between the inorganic particles, the first conductive agent, and the first binder is (50 to 95): (0.5 to 10): (2 to 49.5). In some embodiments, the inorganic particles include at least one selected from the group consisting of boehmite, diaspore, aluminum oxide, barium sulfate, calcium sulfate, and calcium silicate.

In some embodiments, Dᵥ₅₀ of the inorganic particles is D₀ μm, 0.3≤D₀≤5. In some embodiments, 0.6≤D₀≤3. Dᵥ₅₀ means a particle diameter value at which the cumulative volume percentage reaches 50% in a volume-based particle size distribution curve viewed from small diameters to large diameters. In some embodiments, in a case that the dosage of the inorganic particles is constant, the value of D₀ is inversely proportional to the BET specific surface area of the inorganic particles. When the thickness of the first layer 102, the area of orthographic projection of the first layer 102 (S₁ mm²), and the area of orthographic projection of the second layer 103 (S₂ mm²) satisfy: d₁/S₁≥2×10⁻⁶ and d₁/S₂≥2.5'10⁻⁶, if D₀ is relatively small, the inorganic particles may be agglomerated; and, if D₀ is relatively large, then the BET of the inorganic particles is deficient, the coverage of the inorganic particles may be low, and the insulation effect and safety performance of the first layer 102 may be impaired. In some embodiments, Dᵥ₅₀ (D₀) of the inorganic particles and the area of orthographic projection S₂ of the second layer 103 satisfy: 2.1×10⁻⁶≤D₀/S₂≤8.6×10⁻⁴. The Dᵥ₅₀ of the inorganic particles and the area of orthographic projection S₂ of the second layer 103 can reflect the proportional relationship between the BET of the inorganic particles and the area of orthographic projection S₂, that is, the relationship between the coverage rate of the inorganic particles and the area of orthographic projection S₂ of the second layer 103. By making the Dᵥ₅₀ of the inorganic particles and the area of orthographic projection S₂ of the second layer 103 fall within the above range, relatively high safety performance of the electrochemical device is ensured.

In some embodiments, the first conductive agent includes at least one selected from the group consisting of conductive carbon black, carbon fibers, graphene, and carbon nanotubes. In some embodiments, the first binder includes at least one selected from the group consisting of polypropylene, a polyacrylate ester, an acrylonitrile multi-copolymer, and a carboxymethyl cellulose salt. In some embodiments, a bonding force between the first layer 102 and the positive current collector 101 is greater than or equal to 150 N/m. This setting can reduce the probability of peeling off the first layer 102 from the positive current collector 101 during a drop, thereby enhancing safety performance of the electrochemical device.

In some embodiments, the positive active material may include at least one selected from the group consisting of lithium cobalt oxide, lithium iron phosphate, lithium aluminum oxide, lithium manganese oxide, and lithium nickel cobalt manganese oxide. In some embodiments, the second layer 103 may further include a conductive agent and a binder. In some embodiments, the conductive agent in the second layer 103 may include at least one selected from the group consisting of conductive carbon black, graphite sheets, graphene, and carbon nanotubes. In some embodiments, the binder in the second layer 103 may include at least one selected from the group consisting of polyvinylidene difluoride, poly (vinylidene fluoride-co-hexafluoropropylene), poly (styrene-co-acrylate), poly (styrene-co-butadiene), polyamide, polyacrylonitrile, polyacrylic ester, polyacrylic acid, sodium polyacrylate, sodium carboxymethyl cellulose, polyvinyl acetate, polyvinylpyrrolidone, polyvinyl ether, polymethyl methacrylate, polytetrafluoroethylene, and polyhexafluoropropylene. In some embodiments, a mass ratio between the positive active material, the conductive agent, and the binder in the second layer 103 is (90 to 99): (0.1 to 10): (0.1 to 10), but this is merely an example, and any other appropriate mass ratio may apply.

In some embodiments, the electrochemical device further includes a negative electrode plate and a separator. The positive electrode plate is separated from the negative electrode plate by the separator in between. In some embodiments, the negative electrode plate includes a negative current collector and a negative active material layer. In some embodiments, the negative active material layer may be disposed on one side or both sides of the negative current collector.

In some embodiments, the negative active material layer may include a negative active material, a conductive agent, and a binder. In some embodiments, the negative active material may include graphite. In some embodiments, the negative active material may include a silicon-based material. In some embodiments, the silicon-based material includes at least one selected from the group consisting of silicon, a silicon-oxygen material, a silicon-carbon material, and a silicon-oxygen-carbon material.

In some embodiments, the conductive agent in the negative active material layer may include at least one selected from the group consisting of conductive carbon black, Ketjen black, graphite flakes, graphene, carbon nanotubes, and carbon fiber. In some embodiments, the binder in the negative active material layer may include at least one selected from the group consisting of carboxymethyl cellulose (CMC), polyacrylic acid, polyvinylpyrrolidone, polyaniline, polyimide, polyamideimide, polysiloxane, styrene butadiene rubber, epoxy resin, polyester resin, polyurethane resin, and polyfluorene. In some embodiments, a mass ratio between the negative active material, the conductive agent, and the binder in the negative active material layer may be (78 to 98.5): (0.1 to 10): (0.1 to 10). Understandably, the materials and mass ratio specified above are merely exemplary, and any other appropriate materials and mass ratio may be used instead. In some embodiments, the negative current collector may be at least one of a copper foil, a nickel foil, or a carbon-based current collector.

In some embodiments, the separator includes at least one selected from the group consisting of polyethylene, polypropylene, polyvinylidene fluoride, polyethylene terephthalate, polyimide, and aramid fiber. For example, the polyethylene includes at least one selected from the group consisting of high-density polyethylene, low-density polyethylene, and ultra-high-molecular-weight polyethylene. Especially, the polyethylene and the polypropylene are highly effective in preventing short circuits, and can improve stability of the battery through a turn-off effect. In some embodiments, a thickness of the separator falls within a range of approximately 3 μm to 20 μm.

In some embodiments, a surface of the separator may further include a porous layer. The porous layer is disposed on at least one surface of the separator. The porous layer includes inorganic particles and a binder. The inorganic particles are at least one selected from the group consisting of aluminum oxide (Al₂O₃), silicon oxide (SiO₂), magnesium oxide (MgO), titanium oxide (TiO₂), hafnium dioxide (HfO₂), tin oxide (SnO₂), ceria (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide, and barium sulfate.

In some embodiments, a diameter of a pore of the separator is within a range of approximately 0.01 μm to 1 μm. The binder in the porous layer is at least one selected from polyvinylidene difluoride, poly (vinylidene difluoride-co-hexafluoropropylene), polyamide, polyacrylonitrile, polyacrylic ester, polyacrylic acid, sodium polyacrylate, sodium carboxymethyl cellulose, polyvinylpyrrolidone, polyvinyl ether, polymethyl methacrylate, polytetrafluoroethylene, and polyhexafluoropropylene. The porous layer on the surface of the separator can improve heat resistance, oxidation resistance, and electrolyte infiltration performance of the separator, and enhance adhesion between the separator and the electrode plate.

In some embodiments of this application, the electrochemical device includes, but is not limited to, a lithium-ion battery. In some embodiments, the electrochemical device further includes an electrolytic solution. The electrolytic solution includes at least one selected from the group consisting of fluoroether, fluoroethylene carbonate, and ether nitrile. In some embodiments, the electrolytic solution further includes a lithium salt. The lithium salt includes lithium bis (fluorosulfonyl) imide and lithium hexafluorophosphate. The concentration of the lithium salt is 1 mol/L to 2 mol/L, and the mass ratio between the lithium bis (fluorosulfonyl) imide and the lithium hexafluorophosphate is 0.06 to 5. In some embodiments, the electrolytic solution may further include a nonaqueous solvent. The nonaqueous solvent may be a carbonate compound, a carboxylate compound, an ether compound, another organic solvent, or any combination thereof.

The carbonate compound may be a chain carbonate compound, a cyclic carbonate compound, a fluorocarbonate compound, or any combination thereof. Examples of the chain carbonate compound are diethyl carbonate (DEC), dimethyl carbonate (DMC), dipropyl carbonate (DPC), methyl propyl carbonate (MPC), ethylene propyl carbonate (EPC), ethyl methyl carbonate (EMC), or any combination thereof. Examples of the cyclic carbonate compound are ethylene carbonate (EC), propylene carbonate (PC), butylene carbonate (BC), vinyl ethylene carbonate (VEC), or any combination thereof. Examples of the fluorocarbonate compound are fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, trifluoromethyl ethylene carbonate, or any combination thereof.

Examples of the carboxylate compound are methyl acetate, ethyl acetate, n-propyl acetate, tert-butyl acetate, methyl propionate, ethyl propionate, propyl propionate, γ-butyrolactone, decanolactone, valerolactone, mevalonolactone, caprolactone, methyl formate, or any combination thereof.

Examples of the ether compound are dibutyl ether, tetraglyme, diglyme, 1,2-dimethoxyethane, 1,2-diethoxyethane, ethoxy-methoxyethane, 2-methyltetrahydrofuran, tetrahydrofuran, or any combination thereof.

Examples of the other organic solvent are dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate ester, or any combination thereof.

An embodiment of this application further provides an electronic device containing the electrochemical device. The electronic device according to this embodiment of this application is not particularly limited, and may be any electronic device known in the prior art. In some embodiments, the electronic device may include, but is not limited to, a notebook computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, unmanned aerial vehicle, lighting appliance, toy, game console, watch, electric tool, flashlight, camera, large household battery, lithium-ion capacitor, or the like.

Some specific embodiments and comparative embodiments are enumerated below to give a clearer description of this application, using a lithium-ion battery as an example.

### Embodiment 1

Preparing a negative electrode plate: Using a 10 μm-thick copper foil as a current collector, mixing graphite, conductive carbon black, and carboxymethyl cellulose at a mass ratio of 97:1.5:1.5, and dispersing the mixture in deionized water to form a slurry. Stirring well, applying the slurry onto the copper foil. Drying the slurry to form a negative active material layer, where the thickness of the negative active material layer is 80 μm. Performing cold-pressing and slitting to obtain a negative electrode plate. Preparing a positive electrode plate: Mixing inorganic particles boehmite, conductive carbon black, and polyacrylate ester at a mass ratio of 90:5:5 in an N-methyl-pyrrolidone solvent system, and stirring well to form a first slurry. Applying the first slurry onto the positive current collector aluminum foil to obtain a first layer. Mixing lithium cobalt oxide as a positive active material, conductive carbon black, and polyvinylidene difluoride (PVDF) as a binder at a mass ratio of 97.2:1.5:1.3 in an N-methyl-pyrrolidone solvent system, and stirring well to form a second slurry. Applying the second slurry onto the first layer to obtain a second layer that is 68 μm thick. Subsequently, performing drying and cold pressing to obtain a positive electrode plate. Specific parameters of the positive electrode plate are set out in Table 1 and Table 2. Preparing a separator: Using 8 um-thick polyethylene (PE) as a substrate of the separator, coating both sides of the substrate of the separator with a 2 um-thick aluminum oxide ceramic layer. Finally, applying polyvinylidene difluoride (PVDF) as a binder at a concentration of 2.5 mg/cm² onto both sides that have been coated with the ceramic layer, and performing oven-drying.

Preparing an electrolyte solution: Mixing lithium hexafluorophosphate with a nonaqueous organic solvent in an environment in which the water content is less than 10 ppm, where the nonaqueous organic solvent is formulated from propylene carbonate (PC), ethylene carbonate (EC), dimethyl carbonate (DMC), and ethyl methyl carbonate (EMC) at a mass ratio of 1:1: 0.5:1, so as to obtain an electrolyte solution in which the lithium salt concentration is 1.15 mol/L.

Preparing a lithium-ion battery: Stacking the positive electrode plate, the separator, and the negative electrode plate sequentially in such a way that the separator is located between the positive electrode plate and the negative electrode plate to serve a function of separation, and winding the stacked structure to obtain an electrode assembly. Putting the electrode assembly in an aluminum plastic film that serves as an outer package. Dehydrating the electrode assembly at 80° C., injecting the electrolytic solution, and performing packaging. Performing steps such as chemical formation, degassing, and shaping to obtain a lithium-ion battery.

The parameters in Comparative Embodiment 1 are the same as those in Embodiment 1 except that the first layer is not applied in the positive electrode plate.

The parameters in Embodiments 2 to 12 and Comparative Embodiments 2 to 3 are the same as those in Embodiment 1 except the differences shown in Table 1 and Table 2.

The parameters in Embodiments 13 to 17 and Comparative Embodiment 4 are the same as those in Embodiment 1 except the differences shown in Table 3.

In addition, in this application, the corresponding parameters are measured by using the following methods.

1. Thickness of the first layer:
a) Taking, in a (25+5)° C. environment, a positive current collector coated with only the first layer and a positive current collector used for applying the first layer.
b) Using a ten-thousandth micrometer to measure, at a minimum of 10 different points, the thickness of the positive current collector used for applying the first layer, and recording an average value of the thicknesses at all the test points as T₀.
c) Using the ten-thousandth micrometer to measure, at a minimum of 10 different points, the thickness of the positive current collector coated with only the first layer, and recording an average value of the thicknesses at all the test points as T₁.
d) The thickness of the first layer is (T₁-T₀).

2. Bonding force

The bonding force between the first layer and the positive current collector is tested by using a GoTech tensile machine by a 90° angle method commonly used in the lithium industry, as detailed below:
a) Making a positive electrode plate with a positive current collector coated with the first layer into strips, and affixing a part of the positive electrode plate to a steel sheet from one end of the positive electrode plate along a length direction by means of double-sided tape.
b) Fixing the steel sheet to a corresponding position of the GoTech tensile machine, and pulling up a part of the positive electrode plate, the part being not adhered to the steel sheet. Putting the positive electrode plate into a collet directly or by means of a connector, so as to clamp the positive electrode plate. Starting the test with the GoTech tensile machine when the tensile force at the gripping jaw is greater than 0 kgf and less than 0.02 kgf.

c) Determining an average value of the tensile forces measured in a steady region, and recording the average value as a bonding force between the first layer and the positive current collector.

3. Internal resistance of the first layer
a) Measuring the internal resistance with a film resistance instrument manufactured by Initial Energy Science & Technology Co. Ltd.
b) Keeping the supply voltage of the instrument at 220 V, and keeping the air pressure at more than 0.7 MPa.
c) Taking out the positive electrode plate in the fully discharged state of the battery, and placing the cut-out positive electrode plate (60 mm×80 mm) flat in a specimen holder.
d) Placing the specimen holder into a test chamber of the instrument to start the test.
e) Setting the test air pressure to “0” throughout the test.

4. Pass rate of a nail penetration test

Charging a lithium-ion battery as a specimen at a constant current of 0.05 C until the voltage reaches 4.50 V (that is, a full-charge voltage), and then charging the battery at a constant voltage of 4.50 V until the current drops to 0.025 C (that is, a cut-off current) so that the lithium-ion battery reaches a fully charged state. Recording the appearance of the lithium-ion battery before the nail penetration test. Performing a nail penetration test on the battery in a 25+3° C. environment, where the nail is 4 mm in diameter, the penetration speed is 30 mm/s, and the nail penetration position is the planar geometric center of the lithium-ion battery. Stopping the nail penetration test when the test duration reaches 3.5 minutes or the surface temperature of the electrode assembly drops to 50° C. Observing the status of the lithium-ion batteries in groups during the test by using 10 lithium-ion batteries as one group. Determining pass of one test if the battery does not catch fire or explode, and determining pass of the nail penetration test if the battery passes at least 7 tests per 10 tests.

5. Cycle life of the battery
a) Placing a lithium-ion battery into a 25+3° C. environment.
b) Charging the lithium-ion battery at a constant current of 1 C until the voltage reaches 4.50 V, and then charging the battery at a constant voltage of 4.50 V until the current is less than or equal to 0.025 C. Subsequently, discharging the battery at a constant current of 0.5 C until the voltage is less than or equal to 2.75 V, thereby completing one charge-and-discharge cycle.
c) Repeating the above operations until the capacity of the lithium-ion battery is lower than 80%. Recording the number of cycles at this time as the cycle life of the lithium-ion battery.

6. Pass rate of a drop test

Performing a drop test with reference to the national standard GB 8897.4-2008, and recording the drop test pass rate in the form of “number of tests passed/total number of tests”.

Table 1 and Table 2 show parameters and evaluation results in Embodiments 1 to 12 and Comparative Embodiments 1 to 3.

TABLE 1

| | | Area of | Area of | Thickness of | | | | |
|---|---|---|---|---|---|---|---|---|
| | Thickness | orthographic | orthographic | positive | | | | |
| | of first | projection | projection of | current | | | | |
| | layer d₁ | of first layer | second layer | collector | D₀ | | | |
| | (μm) | S₁ (mm²) | S₂ (mm²) | (μm) | (μm) | d₁/S₁ | d₁/S₂ | D₀/S₂ |
| Embodiment | 1 | 230514 | 214977 | 10 | 1.5 | 4.3E−06 | 4.7E−06 | 7.0E−06 |
| 1 | | | | | | | | |
| Embodiment | 3 | 230514 | 214977 | 10 | 1.5 | 1.3E−05 | 1.4E−05 | 7.0E−06 |
| 2 | | | | | | | | |
| Embodiment | 5 | 230514 | 214977 | 10 | 1.5 | 2.2E−05 | 2.3E−05 | 7.0E−06 |
| 3 | | | | | | | | |
| Embodiment | 7 | 230514 | 214977 | 10 | 1.5 | 3.0E−05 | 3.3E−05 | 7.0E−06 |
| 4 | | | | | | | | |
| Embodiment | 5 | 230514 | 214977 | 12 | 1.5 | 2.2E−05 | 2.3E−05 | 7.0E−06 |
| 5 | | | | | | | | |
| Embodiment | 5 | 230514 | 214977 | 7 | 1.5 | 2.2E−05 | 2.3E−05 | 7.0E−06 |
| 6 | | | | | | | | |
| Embodiment | 5 | 230514 | 214977 | 10 | 0.6 | 2.2E−05 | 2.3E−05 | 2.8E−06 |
| 7 | | | | | | | | |
| Embodiment | 5 | 230514 | 214977 | 10 | 3 | 2.2E−05 | 2.3E−05 | 1.4E−05 |
| 8 | | | | | | | | |
| Embodiment | 5 | 230514 | 214977 | 10 | 5 | 2.2E−05 | 2.3E−05 | 1.4E−05 |
| 9 | | | | | | | | |
| Embodiment | 5 | 230514 | 214977 | 10 | 7 | 2.2E−05 | 2.3E−05 | 3.3E−05 |
| 10 | | | | | | | | |
| Embodiment | 11 | 230514 | 214977 | 10 | 1.5 | 4.8E−05 | 5.1E−05 | 7.0E−06 |
| 11 | | | | | | | | |
| Embodiment | 0.5 | 184410 | 171980 | 10 | 1.5 | 2.7E−06 | 2.9E−06 | 8.7E−06 |
| 12 | | | | | | | | |
| Comparative | / | / | 214977 | 10 | / | / | / | / |
| Embodiment | | | | | | | | |
| 1 | | | | | | | | |
| Comparative | 0.2 | 230514 | 214977 | 10 | 1.5 | 8.7E−07 | 9.3E−07 | 7.0E−06 |
| Embodiment | | | | | | | | |
| 2 | | | | | | | | |
| Comparative | 0.5 | 280180 | 261150 | 10 | 1.5 | 1.8E−06 | 1.9E−06 | 5.7E−06 |
| Embodiment | | | | | | | | |
| 3 | | | | | | | | |

TABLE 2

| | Bonding | Internal resistance | Pass rate of nail | | Drop test |
|---|---|---|---|---|---|
| | force (N/m) | of first layer (Ω) | penetration test | Cycle life of battery | pass rate |
| Embodiment 1 | >200 | 1 | 8/10P | 900 cycles fulfilled | 7/10P |
| Embodiment 2 | >200 | 2 | 8/10P | 1000 cycles fulfilled | 8/10P |
| Embodiment 3 | >200 | 4 | 10/10P | 1000 cycles fulfilled | 9/10P |
| Embodiment 4 | >200 | 8 | 10/10P | 1000 cycles fulfilled | 8/10P |
| Embodiment 5 | >200 | 4 | 10/10P | 1000 cycles fulfilled | 10/10P |
| Embodiment 6 | >200 | 4 | 10/10P | 1000 cycles fulfilled | 7/10P |
| Embodiment 7 | >200 | 3 | 9/10P | 1000 cycles fulfilled | 10/10P |
| Embodiment 8 | >200 | 6 | 10/10P | 1000 cycles fulfilled | 10/10P |
| Embodiment 9 | >200 | 6 | 9/10P | 1000 cycles fulfilled | 9/10P |
| Embodiment 10 | >150 | 9 | 7/10P | 1000 cycles fulfilled | 8/10P |
| Embodiment 11 | >200 | 23 | 10/10P | 700 cycles fulfilled | 9/10P |
| Embodiment 12 | >200 | 0.8 | 7/10P | 900 cycles fulfilled | 7/10P |
| Comparative | / | / | 0/10P | 1000 cycles fulfilled | 2/10P |
| Embodiment 1 | | | | | |
| Comparative | >200 | 0.5 | 4/10P | 1000 cycles fulfilled | 5/10P |
| Embodiment 2 | | | | | |
| Comparative | >200 | 0.8 | 5/10P | 900 cycles fulfilled | 5/10P |
| Embodiment 3 | | | | | |

As can be seen from Embodiments 1 to 4 versus Comparative Embodiments 1 to 2, or from Embodiment 12 versus Comparative Embodiment 3, both the nail penetration test pass rate and the drop test pass rate of the lithium-ion battery are improved significantly in contrast to the positive electrode plate in which the first layer is not formed, or in contrast to the positive electrode plate that fails to satisfy d₁/S₁≥2×10⁻⁶ and d₁/S₂≥2.5×10⁻⁶.

As can be seen from Embodiments 1 to 4 and Embodiment 11 versus Comparative Embodiment 2, when the thickness d₁ of the first layer falls within the range of 0.5 um to 10 μm, the nail penetration test pass rate and the drop test pass rate of the lithium-ion battery are improved more significantly, and the cycle performance is relatively good.

As can be seen from comparison of Embodiments 5 to 6, when the thickness of the positive current collector is 7 μm to 12 μm, both the nail penetration test pass rate and the drop test pass rate of the lithium-ion battery are improved effectively.

As can be seen from comparison of Embodiments 7 to 8, when D₀ and the area of orthographic projection S₂ of the second layer satisfy: 2.1×10⁻⁶≤D₀/S₂≤8.6×10⁻⁴, the nail penetration test pass rate of the lithium-ion battery is improved effectively. In Embodiment 10, the value of Dᵥ₅₀ (D₀) of the inorganic particles in the first layer is relatively high, so that the coverage rate of the first layer is reduced and a local part is affected to some extent during the nail penetration test.

Table 3 shows parameters and evaluation results of Embodiments 13 to 17 and Comparative Embodiment 4.

TABLE 3

| | Content | | Content of | | | | | |
|---|---|---|---|---|---|---|---|---|
| | of first | Content of | inorganic | | | | | |
| | binder of | conductive | particles | | Internal | Pass rate | | Drop |
| | first | carbon black | aluminum oxide | Bonding | resistance | of nail | | test |
| | layer | of first layer | of first layer | force | of first | penetration | Cycle life of | pass |
| | (wt %) | (wt %) | (wt %) | (N/m) | layer (Ω) | test | battery | rate |
| Embodiment | 2% | 5% | 93% | 152 | 0.5 | 10/10P | 1000 cycles | 7/10P |
| 13 | | | | | | | fulfilled | |
| Embodiment | 10% | 5% | 85% | 169 | 2 | 10/10P | 1000 cycles | 9/10P |
| 14 | | | | | | | fulfilled | |
| Embodiment | 30% | 5% | 65% | 196 | 4 | 10/10P | 1000 cycles | 10/10P |
| 15 | | | | | | | fulfilled | |
| Embodiment | 50% | 5% | 45% | 228 | 10 | 9/10P | 1000 cycles | 10/10P |
| 16 | | | | | | | fulfilled | |
| Embodiment | 1.50% | 5% | 93.5% | 138 | 21 | 10/10P | 800 cycles | 7/10P |
| 17 | | | | | | | fulfilled | |
| Comparative | 55% | 5% | 40% | 235 | 15 | 6/10P | 800 cycles | 7/10P |
| Embodiment | | | | | | | fulfilled | |
| 4 | | | | | | | | |

As can be seen from Embodiments 13 to 17 versus Comparative Embodiment 4, when the mass ratio between the inorganic particles, the first conductive agent, and the first binder in the first layer is (50 to 95): (0.5 to 10): (2 to 49.5), the nail penetration test pass rate and the drop test pass rate of the lithium-ion battery are improved more significantly, and the cycle life of the lithium-ion battery is longer.

What is described above is merely exemplary embodiments of this application and the technical principles thereof. A person skilled in the art understands that the scope of disclosure in this application is not limited to the technical solutions formed by a specific combination of the foregoing technical features, but covers other technical solutions formed by arbitrarily combining the foregoing technical features or equivalents thereof, for example, a technical solution formed by replacing any of the foregoing features with a technical feature disclosed herein and serving similar functions.

What is claimed is:

1. An electrochemical device, comprising:
a jelly-roll electrode assembly; wherein:
the jelly-roll electrode assembly comprises a positive electrode plate, a negative electrode plate, and a separator, disposed between the positive electrode plate and the negative electrode plate;
the positive electrode plate comprises a positive current collector, a first layer, and a second layer; the first layer is disposed on a surface of the positive current collector, and the second layer is disposed on a surface of the first layer;
the first layer comprises inorganic particles; based on a mass of the first layer, a mass percent of the inorganic particles is greater than or equal to 50%; the second layer comprises a positive active material; based on a mass of the second layer, a mass percent of the positive active material is greater than 90%;
a thickness of the first layer is d₁ μm, an area of orthographic projection of the first layer on the positive current collector is S₁ mm², and an area of orthographic projection of the second layer on the positive current collector is S₂ mm², d₁/S₁≥2×10⁻⁶, and d₁/S₂≥2.5×10⁻⁶; and
a packaging shell, wherein the first layer is in contact with the packaging shell.

2. The electrochemical device according to claim 1, wherein 8×10⁴≤S₁≤6×10⁵, and 7×10⁴≤S₂≤5.5×10⁵.

3. The electrochemical device according to claim 1, wherein, along a thickness direction of the jelly-roll electrode assembly, an area of orthographic projection of the jelly-roll electrode assembly is S₃ mm², and 1≤(S₁−S₂)/S₃≤2.

4. The electrochemical device according to claim 1, wherein, along a thickness direction of the jelly-roll electrode assembly, an area of orthographic projection of the jelly-roll electrode assembly is S₃ mm², and 1.2≤(S₁−S₂)/S₃≤2.

5. The electrochemical device according to claim 1, wherein the thickness of the first layer is 0.5 μm to 10 μm.

6. The electrochemical device according to claim 1, wherein the thickness of the first layer is 3 μm to 7 μm.

7. The electrochemical device according to claim 1, wherein the positive current collector comprises an aluminum foil, and a thickness of the aluminum foil is 7 μm to 20 μm.

8. The electrochemical device according to claim 1, wherein the first layer further comprises a first conductive agent and a first binder, and a mass ratio between the inorganic particles, the first conductive agent, and the first binder is (50 to 95): (0.5 to 10): (2 to 49.5).

9. The electrochemical device according to claim 1, wherein Dᵥ₅₀ of the inorganic particles is D₀μm, 0.3≤D₀≤5.

10. The electrochemical device according to claim 9, wherein the inorganic particles comprise at least one selected from the group consisting of boehmite, diaspore, aluminum oxide, barium sulfate, calcium sulfate, and calcium silicate.

11. The electrochemical device according to claim 10, wherein the electrochemical device satisfies: 2.1×10⁻⁶≤D₀/S₂≤8.6×10⁻⁴, and 0.6≤D₀≤3.

12. The electrochemical device according to claim 8, wherein the electrochemical device satisfies at least one selected from the group consisting of the following:
1) the first conductive agent comprises at least one selected from the group consisting of conductive carbon black, carbon fibers, graphene, and carbon nanotubes;
2) the first binder comprises at least one selected from the group consisting of polypropylene, a polyacrylate ester, an acrylonitrile multi-copolymer, and a carboxymethyl cellulose salt; and
3) a bonding force between the first layer and the positive current collector is greater than or equal to 150 N/m.

13. An electronic device, comprising an electrochemical device, the electrochemical device comprising:
a jelly-roll electrode assembly; wherein the jelly-roll electrode assembly comprises a positive electrode plate, a negative electrode plate, and a separator, disposed between the positive electrode plate and the negative electrode plate;
the positive electrode plate comprises a positive current collector, a first layer, and a second layer; the first layer is disposed on a surface of the positive current collector, and the second layer is disposed on a surface of the first layer;
the first layer comprises inorganic particles; based on a mass of the first layer, a mass percent of the inorganic particles is greater than or equal to 50%; the second layer comprises a positive active material; based on a mass of the second layer, a mass percent of the positive active material is greater than 90%;
a thickness of the first layer is di μm, an area of orthographic projection of the first layer on the positive current collector is S₁ mm², and an area of orthographic projection of the second layer on the positive current collector is S₂ mm², d₁/S₁≥2×10⁻⁶, and d₁/S₂≥2.5×10⁻⁶; and
the electrochemical device further comprises a packaging shell, wherein the first layer is in contact with the packaging shell.

14. The electronic device according to claim 13, wherein 8×10⁴≤S₁≤6×10⁵, and 7×10⁴≤S₂≤5.5×10⁵.

15. The electronic device according to claim 13, wherein, along a thickness direction of the jelly-roll electrode assembly, an orthographic projected area of the jelly-roll electrode assembly is S₃ mm², and 1≤(S₁−S₂)/S₃≤2.

16. The electronic device according to claim 13, wherein, along a thickness direction of the jelly-roll electrode assembly, an orthographic projected area of the jelly-roll electrode assembly is S₃ mm², and 1.2≤(S₁−S₂)/S₃≤2.

17. The electronic device according to claim 13, wherein the thickness of the first layer is 0.5 μm to 10 μm.

18. The electronic device according to claim 13, wherein the thickness of the first layer is 3 μm to 7 μm.

19. The electronic device according to claim 13, wherein the positive current collector comprises an aluminum foil, and a thickness of the aluminum foil is 7 μm to 20 μm.

20. The electronic device according to claim 13, wherein the first layer further comprises a first conductive agent and a first binder, and a mass ratio between the inorganic particles, the first conductive agent, and the first binder is (50 to 95): (0.5 to 10): (2 to 49.5).
